(19) United States
(12) Patent Application Publication
(10) Pub. No.: US 2026/0189709 A1
(43) Pub. Date: Jul. 2, 2026

(54) VIDEO ENCODING METHOD, ELECTRONIC DEVICE AND STORAGE MEDIUM

(71) Applicant: Beijing Zitiao Network Technology Co., Ltd., Beijing (CN)

(72) Inventors: Weihui DENG, Beijing (CN); Bin WANG, Beijing (CN); Xiaocheng LI, Beijing (CN); Zhen WANG, Beijing (CN)

(21) Appl. No.: 19/431,950

(22) Filed: Dec. 23, 2025

(30) Foreign Application Priority Data
Dec. 31, 2024 (CN) 202411998896.7

(51) Int. Cl. H04N 19/136; H04N 19/103

(52) U.S. Cl. CPC H04N 19/136; H04N 19/103

(57) ABSTRACT

A video encoding method, an electronic device, and a storage medium are provided. The method includes: obtaining a first playback feature of a first video within a preset number of time windows in response to a preset trigger; determining a first temporal feature according to the first playback feature and determining a first image quality weight and a first smoothness weight according to the first temporal feature; constructing a first encoding evaluation model according to the first image quality weight and the first smoothness weight; inputting candidate encoding parameter combinations into the first encoding evaluation model to obtain a first encoding evaluation value; determining a first encoding parameter combination from the candidate encoding parameter combinations according to the first encoding evaluation value; and encoding the first video according to the first encoding parameter combination.

### CROSS-REFERENCE TO RELATED APPLICATION(S)

The present application claims priority to Chinese Patent Application No. 202411998896.7, filed on Dec. 31, 2024, which is incorporated herein by reference in its entirety as a part of the present application.

### TECHNICAL FIELD

Embodiments of the present disclosure relate to the field of computer technology.

### BACKGROUND

In related technologies, selection of encoding parameters in the video encoding process significantly impacts the video bit rate, which in turn plays a crucial role in influencing the user's viewing experience. Before distributing a video, a server typically selects multiple encoding parameters to perform multi-level encoding on the video so as to meet the user experience under different playback conditions. There is an urgent need for a video encoding method that can determine a reasonable encoding parameter combination to optimize the overall user experience.

### SUMMARY

An embodiment of the present disclosure provides a video encoding method, which includes: obtaining a first playback feature of a first video within a preset number of time windows in
response to a preset trigger, where the first playback feature includes an image quality feature, a smoothness feature and a playback status feature;
determining a first temporal feature according to the first playback feature and determining a first image quality weight and a first smoothness weight according to the first temporal feature;
constructing a first encoding evaluation model according to the first image quality weight and the first smoothness weight;
inputting candidate encoding parameter combinations into the first encoding evaluation model to obtain a first encoding evaluation value;
determining a first encoding parameter combination from the candidate encoding parameter combinations according to the first encoding evaluation value; and
encoding the first video according to the first encoding parameter combination.

An embodiment of the present disclosure further provides a video encoding apparatus, which includes:
a feature obtaining module, being configured to obtain a first playback feature of a first video within a preset number of time windows in response to a preset trigger, where the first playback feature includes a smoothness feature, an image quality feature and a playback status feature;
a weight determination module, being configured to determine a first temporal feature according to the first playback feature and determine a first image quality weight and a first smoothness weight according to the first temporal feature;
a model construction module, being configured to construct a first encoding evaluation model according to the first image quality weight and the first smoothness weight;
an evaluation module, being configured to input candidate encoding parameter combinations into the first encoding evaluation model to obtain a first encoding evaluation value;
a parameter determination module, being configured to determine a first encoding parameter combination from the candidate encoding parameter combinations according to the first encoding evaluation value; and
an encoding module, being configured to encode the first video according to the first encoding parameter combination.

An embodiment of the present disclosure further provides an electronic device, which includes:
one or more processors; and
a storage apparatus, being configured to store one or more programs,
where when the one or more programs are executed by the one or more processors, the one or more processors implement the video encoding method according to any of the embodiments of the present disclosure.

An embodiment of the present disclosure further provides a storage medium containing computer-executable instructions. The computer-executable instructions are used to implement the video encoding method according to any of the embodiments of the present disclosure when executed by a computer processor.

An embodiment of the present disclosure further provides a computer program product, which is characterized in that the computer program product includes a computer program, and the computer program implements the video encoding method according to any of the embodiments of the present disclosure when executed by a processor.

### BRIEF DESCRIPTION OF DRAWINGS

In conjunction with the accompanying drawings and with reference to the following embodiments, the above and other features, advantages and aspects of the embodiments of the present disclosure will become more apparent. Throughout the drawings, the same or similar reference numerals denote the same or similar elements. It should be understood that the drawings are schematic, and the original figures and elements are not necessarily drawn to scale.

FIG. 1 is a flowchart of a video encoding method provided by an embodiment of the present disclosure;

FIG. 2 is a schematic diagram of optimization of the overall experience quality in a video encoding method provided by an embodiment of the present disclosure;

FIG. 3 is a flowchart of a video encoding method provided by an embodiment of the present disclosure;

FIG. 4 is a schematic block diagram of a data stream of a video encoding method provided by an embodiment of the present disclosure;

FIG. 5 is a structure diagram of a video encoding apparatus provided by an embodiment of the present disclosure; and

FIG. 6 is a structure diagram of an electronic device provided by an embodiment of the present disclosure.

### DETAILED DESCRIPTION

The embodiments of the present disclosure will be described in more detail with reference to the accompanying drawings. Although some embodiments of the present disclosure are shown in the drawings, it should be understood that the present disclosure can be implemented in various forms and should not be interpreted as being limited to the embodiments described here. Instead, these embodiments are provided to enhance a thorough and complete understanding of the present disclosure. It should be understood that the drawings and embodiments of the present disclosure are provided merely for illustrative purposes and are not intended to limit the scope of protection of the present disclosure.

It should be understood that the steps described in the method implementation of the present disclosure can be executed in different orders and/or concurrently. Furthermore, the method implementation may include additional steps and/or have the shown steps omitted. The scope of the present disclosure is not limited in this regard.

The term “including” and its variations used herein mean open-ended inclusion, i.e., “including but not limited to”. The term “based on” means “at least partially based on”. The term “one embodiment” means “at least one embodiment”; the term “another embodiment” means “at least one additional embodiment”; and the term “some embodiments” means “at least some embodiments”. Relevant definitions of other terms will be provided in the following description.

It should be noted that the concepts such as “first” and “second” mentioned in the present disclosure are only used to distinguish different apparatuses, modules or units, and are not intended to define the order of functions performed by these apparatuses, modules or units or their interdependence.

It should be noted that the modifiers “one” and “multiple” mentioned in the present disclosure are illustrative rather than restrictive, and those skilled in the art should understand that these modifiers should be understood as “one or more” unless otherwise expressly stated in the context.

The names of messages or information exchanged between multiple apparatuses in the implementation of the present disclosure are used only for illustrative purposes and are not intended to limit the scope of these messages or information.

It can be understood that the data involved in this technical solution (including but not limited to the data per se, acquisition or use of the data) shall comply with the requirements of corresponding laws and regulations and relevant provisions.

In related technologies, when the video bit rate is low, the video usually has poor image quality. When the video bit rate is high, although the image quality is improved, the risk of smoothness issues is increased, e.g., a higher lag rate and a longer playback wait time. Before distributing the video, the server usually selects multiple encoding parameters to perform multi-level encoding on the video so as to balance the overall user experience in terms of image quality and smoothness in the process of watching the video.

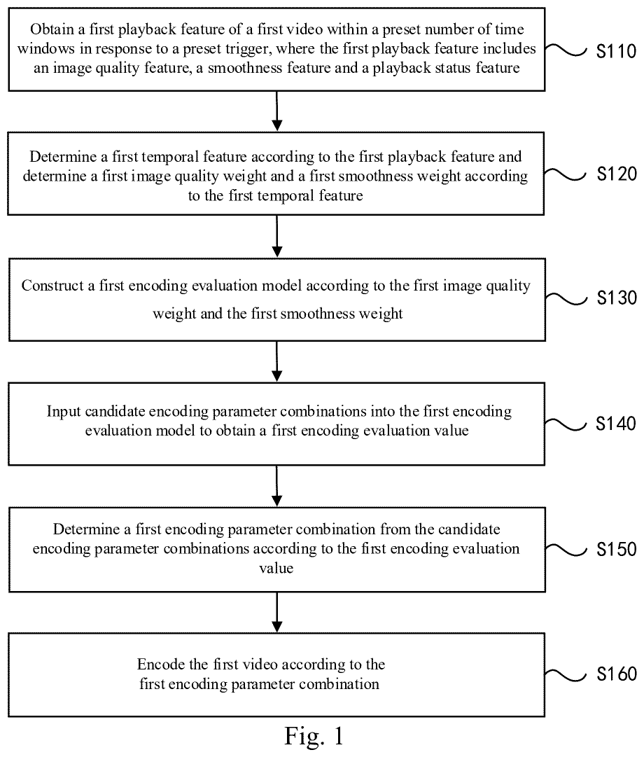

FIG. 1 is a flowchart of a video encoding method provided by an embodiment of the present disclosure. The embodiment of the present disclosure is suitable for scenarios of video encoding, e.g., a scenario where the server performs multi-level encoding on the video through an encoding parameter combination before distributing the video. The method can be executed by a video encoding apparatus, which can be implemented in the form of software and/or hardware and configured within an electronic device, e.g., a server.

As shown in FIG. 1, the video encoding method provided in this embodiment may include S110 to S160.
S110: obtaining a first playback feature of a first video within a preset number of time windows in response to a preset trigger, where the first playback feature includes an image quality feature, a smoothness feature and a playback status feature.

In the embodiment of the present disclosure, the preset trigger may be set according to specific application scenarios. For example, the preset trigger may include a trigger of a preset time or a trigger of a preset event. The preset time may include a time at each preset time interval. The preset time interval and the duration corresponding to the time windows may be set according to specific application scenarios. The preset time interval may be related to or unrelated to the duration corresponding to the time windows. When the preset time interval is related to the duration corresponding to the time windows, the preset time interval for example may be equal to the duration corresponding to the time windows or a positive integer multiple of it.

The preset number of time windows may include at least two time windows, and the preset number is usually a positive integer. The first playback feature within each time window may include an image quality feature, a smoothness feature and a playback status feature. The image quality feature may include features of at least one of the following dimensions: the video frame rate, the video quality, etc. The smoothness feature may include features of at least one of the following dimensions: the lag rate, the lag duration, the duration of the first frame, etc. The playback status feature may include features of at least one of the following dimensions: the playback duration, the completion rate, the number of plays, etc.

In the embodiment of the present disclosure, the video encoding apparatus may be deployed in the server. The first video may include a valid video that has been posted on the target video platform, e.g., a short video or a long video. The target video platform may be considered to correspond to the server. The server may obtain a first playback feature of a first video within a preset number of time windows before the time of a preset trigger in response to the preset trigger. Attribute parameter values corresponding to features in each dimension in the first playback feature may be determined by using the existing method of constructing statistical aggregation feature values. The statistical aggregation feature values may include, but are not limited to, mean values, quantiles, etc. Furthermore, the features in the corresponding dimensions may be determined according to the attribute parameter values. For example, the features in the dimensions corresponding to the attribute parameter values may be determined through the existing embedding extraction network.

For example, the server can, upon reaching the preset time t, obtain the first playback feature of the first video within k time windows before the preset time t. Assuming the length of each time window is L, the k time windows may be represented as {[t−kL, t−(k+1)L], . . . , [t−L, t]}. For example, when the feature in the video frame rate dimension in the first playback feature is obtained, for each time window, the average video frame rate of the first video within the time window may be calculated firstly; and then, the feature in the video frame rate dimension may be determined according to the average video frame rate by the existing feature extraction method.
S120: determining a first temporal feature according to the first playback feature and determining a first image quality weight and a first smoothness weight according to the first temporal feature.

In the embodiment of the present disclosure, the first temporal feature may be extracted from the first playback feature by the existing method for extracting the first temporal feature. Extracting the first temporal feature from the first playback feature may include extracting the temporal feature from the image quality feature, the smoothness feature and the playback status feature in the first playback feature respectively. For example, the temporal features corresponding to the image quality feature, the smoothness feature and the playback status feature may be extracted respectively through a transformer-based neural network model. It may be considered that the temporal feature of the image quality feature, the temporal feature of the smoothness feature and the temporal feature of the playback status feature in the first playback feature all belong to the first temporal feature of the first playback feature.

The corresponding relationship between the temporal features and the image quality weight and the smoothness weight may be constructed in advance. For example, the corresponding relationship between the temporal features and the image quality weight and the smoothness weight may be constructed through mathematical modeling or neural network modeling. Accordingly, the first image quality weight and the first smoothness weight corresponding to the first video under the preset trigger may be determined based on the corresponding relationship constructed in advance and according to the first temporal feature corresponding to the first video under the preset trigger.
S130: constructing a first encoding evaluation model according to the first image quality weight and the first smoothness weight.

In the embodiment of the present disclosure, the first encoding evaluation model may be considered as a mathematical model. The first image quality weight and the first smoothness weight may represent target changes in the encoding service of the first video at the time of the preset trigger (i.e., they are more inclined to ensure the image quality or the smoothness). The encoding evaluation of the user is closely linked to the Quality of Service (QoS) (i.e., the higher the QoS, the higher the encoding evaluation), so the first encoding evaluation model may be constructed according to the first image quality weight and the first smoothness weight as well as the image quality QoS and the smoothness QoS under different encoding parameters in this embodiment.

In some optional implementations, constructing a first encoding evaluation model according to the first image quality weight and the first smoothness weight may include: constructing an image quality encoding evaluation item according to the first image quality weight and an image quality QoS item; constructing a smoothness encoding evaluation item according to the first smoothness weight and a smoothness QoS item; and constructing the first encoding evaluation model according to the image quality encoding evaluation item and the smoothness encoding evaluation item. The image quality QoS item is obtained based on the playback probability and an image quality attribute parameter of all the videos on the platform to which the first video belongs under different encoding parameters. The smoothness QoS item is obtained based on the playback probability and smoothness attribute parameters of all the videos under different encoding parameters.

For example, the first encoding evaluation model may be represented by the following formula:

$$QoE = {\int }_{{R}_{1} , . . {R}_{n}} α \times {QoS}_{q , j} ( {R}_{j} ) + β \times {QoS}_{f , j} ( {R}_{j} ) {dR}_{j}$$

Where α and β may represent the first image quality weight and the first smoothness weight respectively; QoS_{q,j}(Rⱼ) and QoS_{f,j}(Rⱼ) may represent the image quality QoS item and the smoothness QoS item respectively; α×QoS_{q,j}(Rⱼ) and β×QoS_{f,j}(Rⱼ) may represent the image quality encoding evaluation item and the smoothness encoding evaluation item respectively; and the first encoding evaluation model may be constructed by integrating the sum of the image quality encoding evaluation item and the smoothness encoding evaluation item in the dimension of the encoding parameter Rⱼ∈(R₁, . . . Rₙ).

The image quality QoS item QoS_{q,j}(Rⱼ) may be obtained based on the playback probability p(Rⱼ) of the video with the encoding parameter Rⱼ on the platform to which the first video belongs and the estimated value QoS′_{q,j}(Rⱼ) of the image quality attribute parameter. The smoothness QoS item QoS_{f,j}(Rⱼ) may be obtained based on the playback probability p(Rⱼ) of the video with the encoding parameter Rⱼ on the platform to which the first video belongs and the estimated value QoS′_{f,j}(Rⱼ) of the smoothness attribute parameter. For example, the image quality QoS item or the smoothness QoS item may be represented by the following formula:

$$Q o {S}_{* , j} ( {R}_{j} ) = p ( {R}_{j} ) \times Q o {S}_{* , j}^{′} ( {R}_{j} ) = {\int }_{{R}_{j - 1}}^{{R}_{j}} p ( R ) dR \times {QoS}_{* , j}^{′} ( {R}_{j} ) ;$$

Where QoS_{*,j}(Rⱼ) may represent the image quality QoS item or the smoothness QoS item; the playback probability p(Rⱼ) of the video with the encoding parameter Rⱼ on the platform to which the first video belongs may be obtained by integrating the playback probability p(R) from the encoding parameter Rⱼ₋₁ to the encoding parameter Rⱼ; and QoS′_{*,j}(Rⱼ) may represent the estimated value of the image quality attribute parameter or the smoothness attribute parameter with the encoding parameter Rⱼ respectively.

QoS′_{*,j}(Rⱼ) may include the estimated value of an attribute parameter in at least one dimension, and may be obtained through numerical fitting of attribute parameters of the video with the encoding parameter Rⱼ on the platform to which the first video belongs. For example, the estimated value QoS′_{f,j}(Rⱼ) of the smoothness attribute parameter may be obtained through numerical fitting of attribute parameters in at least one dimension (such as the lag rate, the lag duration and the duration of the first frame,) of the video with the encoding parameter Rⱼ on the platform to which the first video belongs.

In these optional implementations, the corresponding image quality QoS item and smoothness QoS item under different encoding parameters may be estimated in advance based on the historical playback data of the videos on the platform, and then the first encoding evaluation model may be established by combining the first image quality weight and the first smoothness weight.
S140: inputting candidate encoding parameter combinations into the first encoding evaluation model to obtain a first encoding evaluation value.

In this embodiment, the encoding parameters may include parameters in dimensions such as the resolution and the constant rate factor (CRF). The encoding parameters supported by the server may be enumerated in advance. For example, when resolutions of the encoding supported by the server may include 480P, 720P and 1080P and 5 levels of CRF values may be included at each resolution, then the server may support 3×5=15 encoding parameters for video encoding.

The input to the first encoding evaluation model may include the candidate encoding parameter combinations. The candidate encoding parameter combinations may include at least two supported encoding parameters, and may be obtained through random selection from the supported encoding parameters. The output value of the first encoding evaluation model may be referred to as the first encoding evaluation value.
S150: determining a first encoding parameter combination from the candidate encoding parameter combinations according to the first encoding evaluation value.

Settings may be made according to specific scenarios. The first encoding parameter combination is determined from the candidate encoding parameter combinations according to the first encoding evaluation value. For example, the first encoding parameter combination may be determined according to the candidate encoding parameter combinations corresponding to the first encoding evaluation value greater than a preset value. As another example, the candidate encoding parameter combination corresponding to the maximum first encoding evaluation value may be determined as the first encoding parameter combination. The greater the first encoding evaluation value output by the first encoding evaluation model, the better the overall user experience quality. By determining the input candidate encoding parameter combination corresponding to the maximum output as the first encoding parameter combination, the overall user experience may be optimized.
S160: encoding the first video according to the first encoding parameter combination.

The first video may be encoded according to the encoding parameters included in the first parameter combination by the existing video encoding method. The encoded first video may be distributed to each client for playback. During the playback of the first video, the attribute parameter values corresponding to features in each dimension in the first playback feature may be detected. The detected attribute parameter values may be used to obtain the first playback feature corresponding to the first video in response to the subsequent preset trigger.

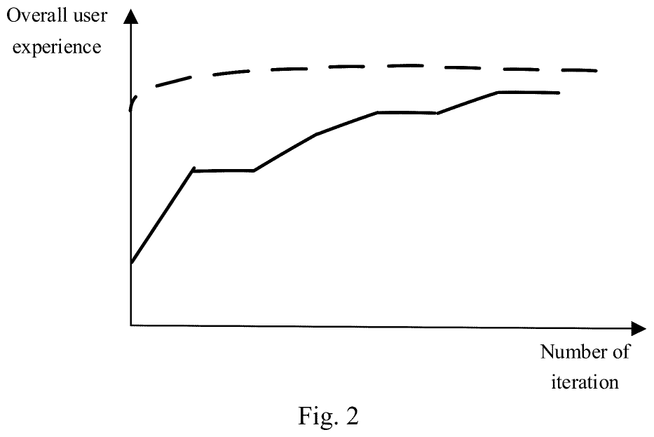

For example, FIG. 2 is a schematic diagram of optimization of the overall experience quality in a video encoding method provided by an embodiment of the present disclosure. In the curve shown in FIG. 2, the horizontal axis may represent the number of iterations of the encoding combination, while the vertical axis may represent the overall user experience. The dashed line in FIG. 2 may represent the ideal overall user experience of the first video; and the solid line may represent the actual overall user experience of the first video after determining the corresponding first encoding parameter combination in response to each preset trigger and performing encoding based on the first encoding parameter combination.

In FIG. 2, in the entire consumption cycle of the first video, the first playback feature within the preset number of time windows is obtained at the time of the preset trigger and the first temporal feature is extracted from the first playback feature so as to determine the first image quality weight and the first smoothness weight that represent the target changes in the encoding service of the first video at the time of the preset trigger. This enables continuous iteration of optimal encoding parameter combinations, thus bringing the actual overall user experience closer to the ideal overall user experience.

In the technical solution of the embodiment of the present disclosure, a first playback feature of a first video within a preset number of time windows may be obtained in response to a preset trigger, where the first playback feature includes an image quality feature, a smoothness feature and a playback status feature; a first temporal feature is determined according to the first playback feature and a first image quality weight and a first smoothness weight are determined according to the first temporal feature; a first encoding evaluation model is constructed according to the first image quality weight and the first smoothness weight; candidate encoding parameter combinations are input into the first encoding evaluation model to obtain a first encoding evaluation value; a first encoding parameter combination is determined from the candidate encoding parameter combinations according to the first encoding evaluation value; and the first video is encoded according to the first encoding parameter combination.

By obtaining the first playback feature within the preset number of time windows at the time of the preset trigger, the first temporal feature may be extracted from the first playback feature so as to determine the first image quality weight and the first smoothness weight at the time of the preset trigger. The first image quality weight and the first smoothness weight may represent the target changes in the encoding service of the first video at the time of the preset trigger (i.e., they are more inclined to ensure the image quality or the smoothness). Then, the first encoding evaluation model may be constructed based on the first image quality weight and the first smoothness weight, and the current optimal encoding parameter combination may be derived accordingly. Thereby, the target changes in the encoding service of the video may be captured in combination with the first temporal feature in the playback process to determine a reasonable encoding parameter combination so as to optimize the overall user experience.

The embodiments of the present disclosure may be combined with the optional solutions in the video encoding method provided in the above embodiment. The video encoding method provided in this embodiment provides a detailed description of the encoding process for the first video. Using different encoding parameter combinations for video encoding (referred to as transcoding for short) incurs certain resource costs, so in this embodiment, transcoding operations may be performed only when the optimal encoding parameter combination at the time of the preset trigger brings significant improvement in the user experience as compared to the optimal encoding parameter combination at the time of the previous preset trigger. This can decrease the resource consumption of the server while ensuring the overall user experience.

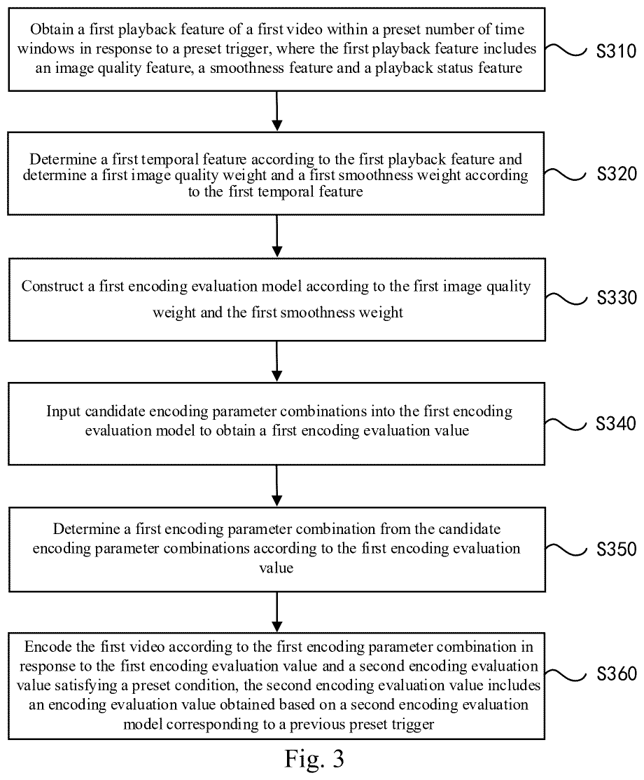

FIG. 3 is a flowchart of a video encoding method provided by an embodiment of the present disclosure. As shown in FIG. 3, the video encoding method provided by this embodiment may include S310 to S360.
S310: obtaining a first playback feature of a first video within a preset number of time windows in response to a preset trigger, where the first playback feature includes an image quality feature, a smoothness feature and a playback status feature.
S320: determining a first temporal feature according to the first playback feature and determining a first image quality weight and a first smoothness weight according to the first temporal feature.
S330: constructing a first encoding evaluation model according to the first image quality weight and the first smoothness weight.
S340: inputting candidate encoding parameter combinations into the first encoding evaluation model to obtain a first encoding evaluation value.
S350: determining a first encoding parameter combination from the candidate encoding parameter combinations according to the first encoding evaluation value.
S360: encoding the first video according to the first encoding parameter combination in response to the first encoding evaluation value and a second encoding evaluation value satisfying a preset condition, where the second encoding evaluation value includes an encoding evaluation value obtained based on a second encoding evaluation model corresponding to the previous preset trigger.

In the embodiment of the present disclosure, refer to steps S310-S330 for the process of constructing the second encoding evaluation model corresponding to the previous preset trigger. The preset condition may include the target difference obtained by subtracting the maximum second encoding evaluation value from the maximum first encoding evaluation value being greater than a preset threshold. For example, the target difference may be represented by the following formula:

$${δ}_{Q o E} = Q o {E}_{t} ( {R}_{1}^{t} , … {R}_{n}^{t} ) - {QoE}_{t - 1} ( {R}_{1}^{t - 1} , … {R}_{n}^{t - 1} ) = {max}_{{R}_{1}^{t} , … {R}_{n}^{t}} \int {α}_{t} \times Q o {S}_{q , j} ( {R}_{j}^{t} ) + {β}_{t} \times Q o {S}_{f , j} ( {R}_{j}^{t} ) {dR}_{j}^{t} - {max}_{{R}_{1}^{t - 1} , … {R}_{n}^{t - 1}} \int {α}_{t - 1} \times Q o {S}_{q , j} ( {R}_{j}^{t - 1} ) + {β}_{t - 1} \times Q o {S}_{f , j} ( {R}_{j}^{t - 1} ) {dR}_{j}^{t - 1}$$

Where t may represent the time of the preset trigger, and t−1 may represent the time of the previous preset trigger. Accordingly, αₜ and βₜ may represent the image quality weight and the smoothness weight (i.e., the first image quality weight and the first smoothness weight) corresponding to the time of the preset trigger respectively; αₜ₋₁ and βₜ₋₁ may represent the image quality weight and the smoothness weight corresponding to the time of the previous preset trigger respectively;

$${R}_{1}^{t} , … {R}_{n}^{t} and {R}_{1}^{t - 1} , … {R}_{n}^{t - 1}$$

may represent the optimal encoding parameter combination (i.e., the first encoding parameter combination) corresponding to the time of the preset trigger and the optimal encoding parameter combination corresponding to the time of the previous preset trigger respectively, and

$$Q o {E}_{t} ( {R}_{1}^{t} , … {R}_{n}^{t} ) and {QoE}_{t - 1} ( {R}_{1}^{t - 1} , … {R}_{n}^{t - 1} )$$

may represent the maximum first encoding evaluation value and the maximum second encoding evaluation value respectively.

Furthermore, in this embodiment, if the first encoding evaluation value and the second encoding evaluation value do not satisfy the preset condition, e.g., the target difference obtained by subtracting the maximum second encoding evaluation value from the maximum first encoding evaluation value is less than or equal to the preset threshold, then the encoding on the first video according to the first encoding parameter combination may be stopped and instead the first video encoded according to the encoding parameter combination corresponding to the time of the previous preset trigger will continue to be distributed.

In the technical solution of the embodiment of the present disclosure, the encoding process of the first video is described in detail. Using different encoding parameter combinations for video encoding (referred to as transcoding for short) incurs certain resource costs, so in this embodiment, transcoding operations may be performed only when the optimal encoding parameter combination at the time of the preset trigger brings significant improvement in the user experience as compared to the optimal encoding parameter combination at the time of the previous preset trigger. This may decrease the resource consumption of the server while ensuring the overall user experience. The video encoding method provided by the embodiment of the present disclosure is of the same disclosure concept as the video encoding method provided by the above embodiments. The technical details not detailed in this embodiment can be found in the above embodiments, and the same technical features have the same beneficial effects in this embodiment and in the above embodiments.

The embodiments of the present disclosure may be combined with the optional solutions in the video encoding method provided in the above embodiments. The video encoding method provided in this embodiment provides a detailed description of the process for determining the first image quality weight and the first smoothness weight. In this embodiment, a preset temporal model and a preset processing model may be constructed synchronously based on the supervised learning method. Accordingly, the temporal feature may be determined through the preset temporal model, and then the first image quality weight and the first smoothness weight are determined according to the temporal feature through the preset processing model. Furthermore, in the process of determining the first image quality weight and the first smoothness weight based on the preset processing model, a second playback feature may be further introduced to increase the accuracy of the first image quality weight and the first smoothness weight, thereby improving the reasonability of the encoding parameter combination.

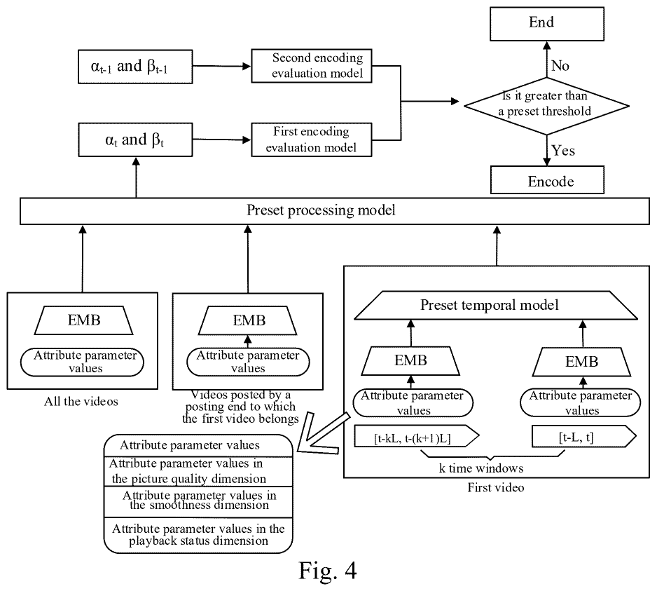

FIG. 4 is a schematic block diagram of a data stream of a video encoding method provided by an embodiment of the present disclosure. As shown in FIG. 4, in the video encoding method provided by this embodiment, determining a first temporal feature according to the first playback feature and determining a first image quality weight and a first smoothness weight according to the first temporal feature may include:

determining the first temporal feature according to the first playback feature through a preset temporal model; and determining the first image quality weight and the first smoothness weight according to the first temporal feature through a preset processing model, where the preset temporal model and the preset processing model are constructed synchronously based on the supervised learning method.

As shown in FIG. 4, the attribute parameters corresponding to features in each dimension of the first playback feature may include, but are not limited to, attribute parameters in the image quality dimension such as the video frame rate and the video quality, attribute parameters in the smoothness dimension such as the lag rate, the lag duration and the duration of the first frame, as well as attribute parameters in the playback status dimension such as the playback duration, the completion rate and the number of plays. In response to a preset trigger, the server may input attribute parameter values corresponding to the features in each dimension of the first playback feature within a preset number of (k as shown in FIG. 4) time windows into the embedding feature extraction network (indicated as EMB in FIG. 4), and determine the features in the dimensions corresponding to the attribute parameter values, i.e., an image quality feature, a smoothness feature and a playback status feature. Thus, the first playback feature may be determined.

In FIG. 4, the first temporal feature may be extracted from the first playback feature within the k time windows through the preset temporal model. Then, the first image quality weight and the first smoothness weight may be determined according to the first temporal feature through the preset processing model. The preset temporal model may, for example, include a transformer-based neural network model; and the preset processing model may, for example, include at least one deep neural network (DNN) model with a fully connected layer. The preset temporal model and the preset processing model may be constructed synchronously in advance based on the supervised learning method and according to sample attribute parameters as well as ground truth of the image quality weight and ground truth of the smoothness weight.

Referring to FIG. 4, in response to the preset trigger, the video encoding method provided by this embodiment may further include: obtaining a second playback feature of a second video within a preset range on a platform to which the first video belongs; accordingly, determining a first image quality weight and a first smoothness weight according to the first temporal feature may include: determining the first image quality weight and the first smoothness weight according to the first temporal feature and the second playback feature.

The second video within the preset range may include at least one selected from the group of: all the videos on the platform to which the first video belongs, and videos posted by a posting end to which the first video belongs. As shown in FIG. 4, the second video may include not only all the videos on the platform to which the first video belongs, but also the videos posted by the posting end to which the first video belongs.

The second playback feature may also include an image quality feature, a smoothness feature and a playback status feature. The attribute parameters corresponding to the features in each dimension of the second playback feature may also include, but are not limited to, attribute parameters in the image quality dimension such as the video frame rate and the video quality, attribute parameters in the smoothness dimension such as the lag rate, the lag duration and the duration of the first frame, as well as attribute parameters in the playback status dimension such as the playback duration, the completion rate and the number of plays.

In FIG. 4, the attribute parameters corresponding to all the videos and the attribute parameters corresponding to the videos posted by the posting end may be input into the embedding feature extraction network (indicated as EMB in FIG. 4) respectively so as to determine the second playback feature. Then, the first image quality weight and the first smoothness weight may be determined according to the first temporal feature and the second playback feature through the preset processing model. It may be considered that, in this context, the sample attribute parameters used to construct the preset temporal model and the preset processing model may include not only the sample attribute parameters of the sample video within the k time windows, but also the sample attribute parameters corresponding to all the videos and the sample attribute parameters corresponding to the videos posted by the posting end to which the sample video belongs. The preset temporal model and the preset processing model may be constructed synchronously according to the sample attribute parameters as well as the ground true of the image quality weight and the ground true of the smoothness weight.

Referring to FIG. 4 again, αₜ and βₜ may represent the image quality weight and the smoothness weight (i.e., the first image quality weight and the first smoothness weight) corresponding to the time of the preset trigger respectively; and αₜ₋₁ and βₜ₋₁ may represent the image quality weight and the smoothness weight corresponding to the time of the previous preset trigger respectively. The first encoding evaluation model may be constructed according to αₜ and βₜ, and the second encoding evaluation model may be constructed according to αₜ₋₁ and βₜ₋₁. If the target difference obtained by subtracting the maximum second encoding evaluation value from the maximum first encoding evaluation value is greater than a preset threshold, then the first video may be encoded according to the first encoding parameter combination; and if the target difference is less than or equal to the preset threshold, then the process may be ended, i.e., the encoding on the first video according to the first encoding parameter combination may be stopped and instead the first video encoded according to the encoding parameter combination corresponding to the time of the previous preset trigger will continue to be distributed.

In the technical solution of the embodiment of the present disclosure, the process for determining the first image quality weight and the first smoothness weight is described in detail. In this embodiment, the preset temporal model and the preset processing model may be constructed synchronously in advance based on the supervised learning method. Accordingly, the temporal feature may be determined through the preset temporal model, and then the first image quality weight and the first smoothness weight are determined according to the temporal feature through the preset processing model. Furthermore, in the process of determining the first image quality weight and the first smoothness weight based on the preset processing model, a second playback feature may be further introduced to increase the accuracy of the first image quality weight and the first smoothness weight, thereby improving the reasonability of the encoding parameter combination. The video encoding method provided by the embodiment of the present disclosure is of the same disclosure concept as the video encoding method provided by the above embodiments. The technical details not detailed in this embodiment can be found in the above embodiments, and the same technical features have the same beneficial effects in this embodiment and in the above embodiments.

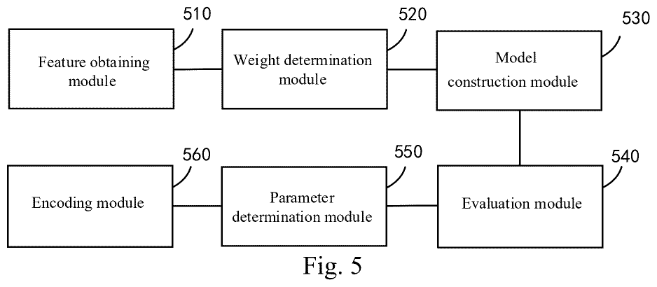

FIG. 5 is a structure diagram of a video encoding apparatus provided by an embodiment of the present disclosure. The video encoding apparatus provided by this embodiment is suitable for scenarios of video encoding, e.g., a scenario where the server performs multi-level encoding on the video through an encoding parameter combination before distributing the video.

As shown in FIG. 5, the video encoding apparatus provided by the embodiment of the present disclosure may include:
a feature obtaining module 510, being configured to obtain a first playback feature of a first video within a preset number of time windows in response to a preset trigger, where the first playback feature includes a smoothness feature, an image quality feature and a playback status feature;
a weight determination module 520, being configured to determine a first temporal feature according to the first playback feature and determine a first image quality weight and a first smoothness weight according to the first temporal feature;
a model construction module 530, being configured to construct a first encoding evaluation model according to the first image quality weight and the first smoothness weight;
an evaluation module 540, being configured to input candidate encoding parameter combinations into the first encoding evaluation model to obtain a first encoding evaluation value;
a parameter determination module 550, being configured to determine a first encoding parameter combination from the candidate encoding parameter combinations according to the first encoding evaluation value; and
an encoding module 560, being configured to encode the first video according to the first encoding parameter combination.

In some optional implementations, the encoding module may be configured to:
encode the first video according to the first encoding parameter combination in response to the first encoding evaluation value and a second encoding evaluation value satisfying a preset condition;
where the second encoding evaluation value includes an encoding evaluation value obtained based on a second encoding evaluation model corresponding to the previous preset trigger.

In some optional implementations, the weight determination module may be configured to:
determine the first temporal feature according to the first playback feature through a preset temporal model; and
determine the first image quality weight and the first smoothness weight according to the first temporal feature through a preset processing model, where the preset temporal model and the preset processing model are constructed synchronously based on the supervised learning method.

In some optional implementations, the feature obtaining module may further be configured to:
obtain a second playback feature of a second video within a preset range on a platform to which the first video belongs in response to the preset trigger.

Accordingly, the weight determination module may be configured to:
determine the first image quality weight and the first smoothness weight according to the first temporal feature and the second playback feature.

In some optional implementations, the second video within the preset range includes at least one selected from the group of: all the videos on the platform to which the first video belongs, and videos posted by a posting end to which the first video belongs.

In some optional implementations, the model construction module may be configured to:
construct an image quality encoding evaluation item according to the first image quality weight and an image quality QoS item;
construct a smoothness encoding evaluation item according to the first smoothness weight and a smoothness QoS item; and
construct the first encoding evaluation model according to the image quality encoding evaluation item and the smoothness encoding evaluation item;
where the image quality QoS item is obtained based on the playback probability and image quality attribute parameters of all the videos on the platform to which the first video belongs under different encoding parameters; and where the smoothness QoS item is obtained based on the playback probability and smoothness attribute parameters of all the videos under different encoding parameters.

In some optional implementations, the parameter determination module may be configured to:
determine the candidate encoding parameter combination corresponding to the maximum first encoding evaluation value as the first encoding parameter combination.

The video encoding apparatus provided by the embodiment of the present disclosure can execute the video encoding method provided by any of the embodiments of the present disclosure, and has functional modules and beneficial effects corresponding to the executed method.

It is worth noting that the units and modules included in the above apparatus are only divided according to functional logic, but are not limited to the above division as long as the corresponding functions can be achieved; and in addition, the specific names of the functional units are only for the convenience of mutual distinction, and are not intended to limit the scope of protection of the embodiments of the present disclosure.

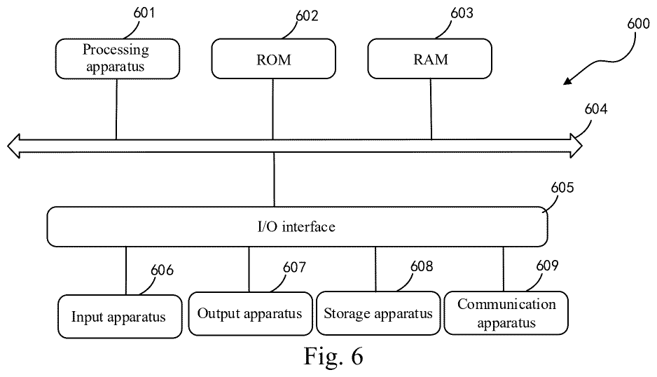

Referring to FIG. 6 below, there is shown a structure diagram of an electronic device (e.g., a terminal device or a server in FIG. 6) 600 suitable for implementing the embodiments of the present disclosure. The terminal device in the embodiment of the present disclosure may include, but is not limited to, mobile terminals such as mobile phones, laptops, digital radio receivers, personal digital assistants (PDAs), portable android devices (PADs), portable multimedia players (PMPs) and in-vehicle terminals (e.g., in-vehicle navigation terminals), and fixed terminals such as digital TVs and desktop computers. The electronic device shown in FIG. 6 is only an example, and should not be construed as limiting the functions and scope of use of the embodiments of the present disclosure.

As shown in FIG. 6, the electronic device 600 may include a processing apparatus (e.g., a central processing unit, a graphics processing unit, etc.) 601, which can execute various appropriate actions and processes according to programs stored in a read-only memory (ROM) 602 or loaded from a storage apparatus 608 into a random access memory (RAM) 603. Various programs and data necessary for the operation of the electronic device 600 are also stored in the RAM 603. The processing apparatus 601, the ROM 602 and the RAM 603 are interconnected via a bus 604. An input/output (I/O) interface 605 is also connected to the bus 604.

Generally, the following apparatuses may be connected to the I/O interface 605: an input apparatus 606 such as a touch screen, a touchpad, a keyboard, a mouse, a camera, a microphone, an accelerometer and a gyroscope; an output apparatus 607 such as a liquid crystal display (LCD), a speaker and a vibrator; a storage apparatus 608 such as a tape and a hard drive; and a communication apparatus 609. The communication apparatus 609 may enable the electronic device 600 to communicate with other devices in a wireless or wired way to exchange data. Although FIG. 6 shows the electronic device 600 with various apparatuses, it should be understood that not all the apparatuses shown are required to be implemented or possessed. Alternatively, more or fewer apparatuses can be implemented or possessed.

Specifically, according to the embodiment of the present disclosure, the process described above with reference to the flowchart can be implemented as a computer software program. For example, the embodiment of the present disclosure includes a computer program product that includes a computer program carried on a non-transitory computer-readable medium. The computer program contains a program code for implementing the method as shown in the flowchart. In such embodiments, the computer program can be downloaded and installed from a network via the communication apparatus 609, or installed from the storage apparatus 608 or the ROM 602. When the computer program is executed by the processing apparatus 601, it performs the above functions defined in the video encoding method of the embodiments of the present disclosure.

The electronic device provided by the embodiment of the present disclosure is of the same disclosure concept as the video encoding method provided by the above embodiments. The technical details not detailed in this embodiment can be found in the above embodiments, and this embodiment has the same beneficial effects as the above embodiments.

An embodiment of the present disclosure provides a storage medium for computer-executable instructions which, when executed by a computer processor, can be used to perform the video encoding method provided in the above embodiments.

It should be noted that the above storage medium of the present disclosure may be a computer-readable signal medium, a computer-readable storage medium, or any combination of both. For example, the computer-readable storage medium may be, but is not limited to, an electrical, magnetic, optical, electromagnetic, infrared or semiconductor system, apparatus or component, or any combination thereof. More specific examples of the computer-readable storage medium may include, but are not limited to: an electrical connection with one or more wires, a portable computer disk, a hard drive, a random access memory (RAM), a read-only memory (ROM), an erasable programmable read-only memory (EPROM) or a flash memory (FLASH), an optical fiber, a portable compact disk read-only memory (CD-ROM), an optical storage component, a magnetic storage component, or any appropriate combination thereof. In the present disclosure, the computer-readable storage medium may be any tangible medium that has an executable instruction contained or stored therein, and the executable instruction can be used by an instruction execution system, an apparatus or a component, or used in conjunction with them. In the present disclosure, the computer-readable signal medium may include a data signal transmitted in the baseband or as part of a carrier, which carries computer-readable executable instructions. Such transmitted data signals may take various forms, including but not limited to electromagnetic signals, optical signals, or any appropriate combination thereof. The computer-readable signal medium may also be any computer-readable medium other than the computer-readable storage medium. The computer-readable signal medium can send, propagate or transmit executable instructions that are used by an instruction execution system, apparatus or component, or used in conjunction with them. The executable instructions contained on the storage medium can be transmitted through any appropriate medium, including but not limited to: wires, optical cables, radio frequency (RF), etc., or any appropriate combination thereof.

In some implementations, the client and the server can communicate using any known or future network protocol such as the Hyper Text Transfer Protocol (HTTP), and can be interconnected with any form or medium of digital data communication (e.g., a communication network). Examples of the communication network include the local area network (“LAN”), the wide area network (“WAN”), the Internet, the ad hoc end-to-end network, and any other known or future network.

The above storage medium may be contained in the above electronic device, or it may exist separately and not be assembled into the electronic device.

The above storage medium carries one or more executable instructions which, when executed by the electronic device, enable the electronic device to:
obtain a first playback feature of a first video within a preset number of time windows in response to a preset trigger, where the first playback feature includes an image quality feature, a smoothness feature and a playback status feature; determine a first temporal feature according to the first playback feature and determine a first image quality weight and a first smoothness weight according to the first temporal feature; construct a first encoding evaluation model according to the first image quality weight and the first smoothness weight; input candidate encoding parameter combinations into the first encoding evaluation model to obtain a first encoding evaluation value; determine a first encoding parameter combination from the candidate encoding parameter combinations according to the first encoding evaluation value; and encode the first video according to the first encoding parameter combination.

The executable instructions for performing the operations of the present disclosure can be written in one or more programming languages or combinations thereof. The one or more programming languages include, but are not limited to, object-oriented programming languages such as Java, Smalltalk and C++, as well as conventional procedural programming languages such as the “C” language or the like. The executable instructions can be executed entirely on the user's computer, partially on the user's computer, as a standalone software package, partially on the user's computer and partially on a remote computer, or entirely on a remote computer or server. In scenarios involving the remote computer, the remote computer can be connected to the user's computer via any type of network (including the local area network (LAN) or the wide area network (WAN)), or can be connected to an external computer (e.g., via the Internet through an Internet service provider).

An embodiment of the present disclosure also provides a computer program product, which includes a computer program. When executed by a processor, the computer program can implement the video encoding method provided by any of the embodiments of the present disclosure.

In the process of implementing the computer program product, the computer program code for performing the operations of the present disclosure can be written in one or more programming languages or combinations thereof. The one or more programming languages include object-oriented programming languages such as Java, Smalltalk and C++, as well as conventional procedural programming languages such as the “C” language or the like. The program code can be executed entirely on the user's computer, partially on the user's computer, as a standalone software package, partially on the user's computer and partially on a remote computer, or entirely on a remote computer or server. In scenarios involving the remote computer, the remote computer can be connected to the user's computer via any type of network (including the local area network (LAN) or the wide area network (WAN)), or can be connected to an external computer (e.g., via the Internet through an Internet service provider).

The flowcharts and block diagrams in the attached figures illustrate the possible architectures, functions and operations of the system, method and computer program product according to various embodiments of the present disclosure. In this regard, each box in the flowcharts or block diagrams can represent a module, a program segment, or part of a code, which contains one or more executable instructions for implementing specified logical functions. It should also be noted that, in some alternative implementations, the functions indicated in the boxes may also occur in a different order than those indicated in the figures. For example, two consecutive boxes can be executed in parallel actually or be executed in reverse order in some times depending on the function involved. It should also be noted that, each box in the block diagrams and/or flowcharts as well as combinations of the boxes in the block diagrams and/or flowcharts can be implemented by using a dedicated hardware-based system designed to perform specified functions or operations, or by using a combination of the dedicated hardware and computer instructions.

The units described in the embodiments of the present disclosure can be implemented through software or hardware. In some cases, the name of a unit or module does not constitute a limitation on the unit or module per se.

The functions described above in this article can be performed at least in part by one or more hardware logic components. For example, non-limiting examples of the hardware logic components that can be used include: a field programmable gate array (FPGA), an application-specific integrated circuit (ASIC), an application-specific standard product (ASSP), a system on Chip (SoC), a complex programmable logic device (CPLD) and so on.

In the context of the present disclosure, the machine-readable medium may be a tangible medium that has a program contained or stored therein to be used by an instruction execution system, apparatus or device or used in conjunction with them. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any appropriate combination thereof. More specific examples of the machine-readable storage medium include an electrical connection based on one or more wires, a portable computer disk, a hard drive, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

According to one or more embodiments of the present disclosure, a video encoding method is provided. The method includes:
obtaining a first playback feature of a first video within a preset number of time windows in response to a preset trigger, where the first playback feature includes an image quality feature, a smoothness feature and a playback status feature;
determining a first temporal feature according to the first playback feature and determining a first image quality weight and a first smoothness weight according to the first temporal feature;
constructing a first encoding evaluation model according to the first image quality weight and the first smoothness weight;
inputting candidate encoding parameter combinations into the first encoding evaluation model to obtain a first encoding evaluation value;
determining a first encoding parameter combination from the candidate encoding parameter combinations according to the first encoding evaluation value; and
encoding the first video according to the first encoding parameter combination.

According to one or more embodiments of the present disclosure, a video encoding method is provided. The method further includes:
In some optional implementations, encoding the first video according to the first encoding parameter combination includes:
encoding the first video according to the first encoding parameter combination in response to the first encoding evaluation value and a second encoding evaluation value satisfying a preset condition.

The second encoding evaluation value includes an encoding evaluation value obtained based on a second encoding evaluation model corresponding to the previous preset trigger.

According to one or more embodiments of the present disclosure, a video encoding method is provided. The method further includes:
in some optional implementations, determining a first temporal feature according to the first playback feature and determining a first image quality weight and a first smoothness weight according to the first temporal feature includes:
determining the first temporal feature according to the first playback feature through a preset temporal model; and
determining the first image quality weight and the first smoothness weight according to the first temporal feature through a preset processing model, where the preset temporal model and the preset processing model are constructed synchronously based on the supervised learning method.

According to one or more embodiments of the present disclosure, a video encoding method is provided. The method further includes:
in some optional implementations, in response to the preset trigger, the method further includes:
obtaining a second playback feature of a second video within a preset range on a platform to which the first video belongs;
accordingly, determining a first image quality weight and a first smoothness weight according to the first temporal feature includes:
determining the first image quality weight and the first smoothness weight according to the first temporal feature and the second playback feature.

According to one or more embodiments of the present disclosure, a video encoding method is provided. The method further includes:
in some optional implementations, the second video within the preset range includes at least one selected from the group of: all the videos on the platform to which the first video belongs, and videos posted by a posting end to which the first video belongs.

According to one or more embodiments of the present disclosure, a video encoding method is provided. The method further includes:
in some optional implementations, constructing a first encoding evaluation model according to the first image quality weight and the first smoothness weight includes:
constructing an image quality encoding evaluation item according to the first image quality weight and an image quality QoS item;
constructing a smoothness encoding evaluation item according to the first smoothness weight and a smoothness QoS item; and
constructing the first encoding evaluation model according to the image quality encoding

evaluation item and the smoothness encoding evaluation item;
where the image quality QoS item is obtained based on the playback probability and image quality attribute parameters of all the videos on the platform to which the first video belongs under different encoding parameters; and where the smoothness QoS item is obtained based on the playback probability and smoothness attribute parameters of all the videos under different encoding parameters.

According to one or more embodiments of the present disclosure, a video encoding method is provided. The method further includes:
in some optional implementations, determining a first encoding parameter combination from the candidate encoding parameter combinations according to the first encoding evaluation value includes:
determining the candidate encoding parameter combination corresponding to the maximum first encoding evaluation value as the first encoding parameter combination.

According to one or more embodiments of the present disclosure, a video encoding apparatus is provided. The apparatus includes:
a feature obtaining module, being configured to obtain a first playback feature of a first video within a preset number of time windows in response to a preset trigger, where the first playback feature includes a smoothness feature, an image quality feature and a playback status feature;
a weight determination module, being configured to determine a first temporal feature according to the first playback feature and determine a first image quality weight and a first smoothness weight according to the first temporal feature;
a model construction module, being configured to construct a first encoding evaluation model according to the first image quality weight and the first smoothness weight;
an evaluation module, being configured to input candidate encoding parameter combinations into the first encoding evaluation model to obtain a first encoding evaluation value;
a parameter determination module, being configured to determine a first encoding parameter combination from the candidate encoding parameter combinations according to the first encoding evaluation value; and
an encoding module, being configured to encode the first video according to the first encoding parameter combination.

The above description is only for the preferred embodiments of the present disclosure and an illustration of the technical principles applied. Those skilled in the art should understand that the scope of disclosure involved in the present disclosure is not limited to the technical solution formed by the specific combination of the above technical features, but also covers other technical solutions formed by any combination of the above technical features or their equivalent features without departing from the above disclosure concept. For example, the scope of disclosure covers the technical solution formed by replacing the above features with the technical features having similar functions disclosed in (but not limited to) the present disclosure.

Furthermore, although the operations are described in a specific order, this should not be construed as requiring that these operations be performed in the specific order shown or in sequence. In certain circumstances, multitasking and parallel processing may be advantageous. Similarly, although several specific implementation details are included in the above discussion, these should not be interpreted as limiting the scope of the present disclosure. Certain features described in the context of a separate embodiment can also be combined to be implemented in a single embodiment. Conversely, the various features described in the context of a single embodiment can also be implemented in multiple embodiments individually or in any appropriate sub-combination.

Although the subject matter has been described using language specific to structural features and/or methodological logical actions, it should be understood that the subject matter defined by the appended claims is not limited to the specific features or actions described above. Rather, the specific features and actions described above are merely exemplary forms for implementing the claims.

1. A video encoding method, comprising:
obtaining a first playback feature of a first video within a preset number of time windows in response to a preset trigger, wherein the first playback feature comprises an image quality feature, a smoothness feature and a playback status feature;
determining a first temporal feature according to the first playback feature and determining a first image quality weight and a first smoothness weight according to the first temporal feature;
constructing a first encoding evaluation model according to the first image quality weight and the first smoothness weight;
inputting candidate encoding parameter combinations into the first encoding evaluation model to obtain a first encoding evaluation value;
determining a first encoding parameter combination from the candidate encoding parameter combinations according to the first encoding evaluation value; and
encoding the first video according to the first encoding parameter combination.

2. The video encoding method according to claim 1, wherein the encoding the first video according to the first encoding parameter combination comprises:
encoding the first video according to the first encoding parameter combination in response to the first encoding evaluation value and a second encoding evaluation value satisfying a preset condition,
wherein the second encoding evaluation value comprises an encoding evaluation value obtained based on a second encoding evaluation model corresponding to a previous preset trigger.

3. The video encoding method according to claim 1, wherein the determining a first temporal feature according to the first playback feature and determining a first image quality weight and a first smoothness weight according to the first temporal feature comprises:
determining the first temporal feature according to the first playback feature through a preset temporal model; and
determining the first image quality weight and the first smoothness weight according to the first temporal feature through a preset processing model, wherein the preset temporal model and the preset processing model are constructed synchronously based on the supervised learning method.

4. The video encoding method according to claim 1, wherein, in response to the preset trigger, the method further comprises:
obtaining a second playback feature of a second video within a preset range on a platform to which the first video belongs;
the determining a first image quality weight and a first smoothness weight according to the first temporal feature comprises:
determining the first image quality weight and the first smoothness weight according to the first temporal feature and the second playback feature.

5. The video encoding method according to claim 4, wherein the second video within the preset range comprises at least one selected from the group consisting of: all videos on a platform to which the first video belongs, and videos posted by a posting end to which the first video belongs.

6. The video encoding method according to claim 1, wherein the constructing a first encoding evaluation model according to the first image quality weight and the first smoothness weight comprises:
constructing an image quality encoding evaluation item according to the first image quality weight and an image quality Quality of Service (QoS) item;
constructing a smoothness encoding evaluation item according to the first smoothness weight and a smoothness Quality of Service item; and
constructing the first encoding evaluation model according to the image quality encoding evaluation item and the smoothness encoding evaluation item;
wherein the image quality Quality of Service item is obtained based on playback probability and image quality attribute parameters of all videos on a platform to which the first video belongs under different encoding parameters, and wherein the smoothness Quality of Service item is obtained based on the playback probability and smoothness attribute parameters of the all videos under different encoding parameters.

7. The video encoding method according to claim 1, wherein the determining a first encoding parameter combination from the candidate encoding parameter combinations according to the first encoding evaluation value comprises:
determining the candidate encoding parameter combination corresponding to a maximum first encoding evaluation value as the first encoding parameter combination.

8. An electronic device, wherein the electronic device comprises:
at least one processor; and
a storage apparatus, being configured to store at least one program,
wherein the at least one program, when executed by the at least one processor, causes the one or more processors to implement a video encoding method, the video encoding method comprises:
obtaining a first playback feature of a first video within a preset number of time windows in response to a preset trigger, wherein the first playback feature comprises an image quality feature, a smoothness feature and a playback status feature;
determining a first temporal feature according to the first playback feature and determining a first image quality weight and a first smoothness weight according to the first temporal feature;
constructing a first encoding evaluation model according to the first image quality weight and the first smoothness weight;
inputting candidate encoding parameter combinations into the first encoding evaluation model to obtain a first encoding evaluation value;
determining a first encoding parameter combination from the candidate encoding parameter combinations according to the first encoding evaluation value; and
encoding the first video according to the first encoding parameter combination.

9. The electronic device according to claim 8, wherein the encoding the first video according to the first encoding parameter combination comprises:
encoding the first video according to the first encoding parameter combination in response to the first encoding evaluation value and a second encoding evaluation value satisfying a preset condition,
wherein the second encoding evaluation value comprises an encoding evaluation value obtained based on a second encoding evaluation model corresponding to a previous preset trigger.

10. The electronic device according to claim 8, wherein the determining a first temporal feature according to the first playback feature and determining a first image quality weight and a first smoothness weight according to the first temporal feature comprises:
determining the first temporal feature according to the first playback feature through a preset temporal model; and
determining the first image quality weight and the first smoothness weight according to the first temporal feature through a preset processing model, wherein the preset temporal model and the preset processing model are constructed synchronously based on the supervised learning method.

11. The electronic device according to claim 8, wherein, in response to the preset trigger, wherein the processor is further configured to:
obtain a second playback feature of a second video within a preset range on a platform to which the first video belongs;
the determining a first image quality weight and a first smoothness weight according to the first temporal feature comprises:
determining the first image quality weight and the first smoothness weight according to the first temporal feature and the second playback feature.

12. The electronic device according to claim 11, wherein the second video within the preset range comprises at least one selected from the group consisting of: all videos on a platform to which the first video belongs, and videos posted by a posting end to which the first video belongs.

13. The electronic device according to claim 8, wherein the constructing a first encoding evaluation model according to the first image quality weight and the first smoothness weight comprises:
constructing an image quality encoding evaluation item according to the first image quality weight and an image quality Quality of Service (QoS) item;
constructing a smoothness encoding evaluation item according to the first smoothness weight and a smoothness Quality of Service item; and
constructing the first encoding evaluation model according to the image quality encoding evaluation item and the smoothness encoding evaluation item;
wherein the image quality Quality of Service item is obtained based on playback probability and image quality attribute parameters of all videos on a platform to which the first video belongs under different encoding parameters, and wherein the smoothness Quality of Service item is obtained based on the playback probability and smoothness attribute parameters of the all videos under different encoding parameters.

14. The electronic device according to claim 8, wherein the determining a first encoding parameter combination from the candidate encoding parameter combinations according to the first encoding evaluation value comprises:
determining the candidate encoding parameter combination corresponding to a maximum first encoding evaluation value as the first encoding parameter combination.

15. A non-transitory storage medium, wherein computer-executable instructions are stored on the non-transitory storage medium, the computer-executable instructions, when executed by a computer processor, causes the computer processor to implement a video encoding method, the video encoding method comprises:
obtaining a first playback feature of a first video within a preset number of time windows in response to a preset trigger, wherein the first playback feature comprises an image quality feature, a smoothness feature and a playback status feature;
determining a first temporal feature according to the first playback feature and determining a first image quality weight and a first smoothness weight according to the first temporal feature;
constructing a first encoding evaluation model according to the first image quality weight and the first smoothness weight;
inputting candidate encoding parameter combinations into the first encoding evaluation model to obtain a first encoding evaluation value;
determining a first encoding parameter combination from the candidate encoding parameter combinations according to the first encoding evaluation value; and
encoding the first video according to the first encoding parameter combination.

16. The non-transitory storage medium according to claim 15, wherein the encoding the first video according to the first encoding parameter combination comprises:
encoding the first video according to the first encoding parameter combination in response to the first encoding evaluation value and a second encoding evaluation value satisfying a preset condition,
wherein the second encoding evaluation value comprises an encoding evaluation value obtained based on a second encoding evaluation model corresponding to a previous preset trigger.

17. The non-transitory storage medium according to claim 15, wherein the determining a first temporal feature according to the first playback feature and determining a first image quality weight and a first smoothness weight according to the first temporal feature comprises:
determining the first temporal feature according to the first playback feature through a preset temporal model; and
determining the first image quality weight and the first smoothness weight according to the first temporal feature through a preset processing model, wherein the preset temporal model and the preset processing model are constructed synchronously based on the supervised learning method.

18. The non-transitory storage medium according to claim 15, wherein, in response to the preset trigger, wherein the computer processor is further configured to:
obtain a second playback feature of a second video within a preset range on a platform to which the first video belongs;
the determining a first image quality weight and a first smoothness weight according to the first temporal feature comprises:
determining the first image quality weight and the first smoothness weight according to the first temporal feature and the second playback feature.

19. The non-transitory storage medium according to claim 18, wherein the second video within the preset range comprises at least one selected from the group consisting of: all videos on a platform to which the first video belongs, and videos posted by a posting end to which the first video belongs.

20. The non-transitory storage medium according to claim 15, wherein the constructing a first encoding evaluation model according to the first image quality weight and the first smoothness weight comprises:
constructing an image quality encoding evaluation item according to the first image quality weight and an image quality Quality of Service (QoS) item;
constructing a smoothness encoding evaluation item according to the first smoothness weight and a smoothness Quality of Service item; and
constructing the first encoding evaluation model according to the image quality encoding evaluation item and the smoothness encoding evaluation item;
wherein the image quality Quality of Service item is obtained based on playback probability and image quality attribute parameters of all videos on a platform to which the first video belongs under different encoding parameters, and wherein the smoothness Quality of Service item is obtained based on the playback probability and smoothness attribute parameters of the all videos under different encoding parameters.
